(19) United States
(12) Patent Application Publication
(10) Pub. No.: US 2009/0278326 A1
(43) Pub. Date: Nov. 12, 2009

(54) Kits, Components and Stackable Trailers for Transporting Containers

(75) Inventors: Leroy J. Rowland, Folly Beach, SC (US); Frank C. Schachte, Charleston, SC (US)

Correspondence Address: DORITY & MANNING, P.A., POST OFFICE BOX 1449, GREENVILLE, SC, 29602-1449, US

(73) Assignee: STACKABLE CHASSIS INTERNATIONAL, LLC, Charleston, SC (US)

(21) Appl. No.: 12/486,294

(22) Filed: Jun. 17, 2009

Related U.S. Application Data
(63) Continuation-in-part of application No. 12/104,045, filed on Apr. 16, 2008.

(51) Int. Cl. B62D 39/00; B63B 25/00

(52) U.S. Cl. 280/33.998; 410/80

(57) ABSTRACT

Stackable trailers, kits, and components for stackable trailers are disclosed. The kits and components provide added functionality to existing or newly manufactured trailers for carrying shipping containers of various sizes. Stackability, modularity, and cost savings can be achieved using the various disclosed components with trailers. Components include outriggers for receiving shipping containers, cradles for receiving trailer wheels, and assemblies for receiving trailer landing gears.

### RELATED APPLICATIONS

The present application is a continuation-in-part of U.S. patent application Ser. No. 12/104,045, filed Apr. 16, 2008, and claims the benefit of that application and incorporates that application by reference for all purposes.

### TECHNICAL FIELD

The present subject matter relates generally to trailers that can be pulled by tractors, and more particularly to kits and components for improving functionality of trailers and trailers incorporating such kits and components, whereby the trailers can transport storage containers and/or be stacked when not in use.

### BACKGROUND

In recent years a substantial amount of cargo is transported by ships in containers. Some large ships cans carry thousands of containers.

After these containers are unloaded at a port, they are transported on trailers pulled by a tractor. A large number of there containers are twenty and forty feet long normally requiring trailers of different lengths.

It has become a problem as shipping increases to store the trailers prior to the ships being unloaded. Space at the ports for storing the trailers is limited since most of ports are located in large cities close to the sea.

Moreover forty foot trailers are not always suitable for transporting twenty foot containers since the load on the trailers would not be balance lengthwise on the trailer. An unbalanced trailer could overload one of the sets of wheels on the tractor trailer. When a trailer is not balanced properly, such increases the damage on the highways that they travel.

The containers that the trailers are provided to transport are normally used to transport freight over land by rail or by ships. The containers are adapted to be mounted on railroad double-stack or flat cars, highway truck trailer chassis's and stored in stacks on ships.

Freight containers which are capable of being stacked in a superimposed relation are known in the prior art. Examples of such containers are disclosed by U.S. Pat. No. 3,044,656.

Each corner of the container is provided with a corner post connected between associated pairs of upper and lower steel castings which comprise load bearing members of the containers. Conventional openings in each of the steel castings facilitate the interlocking of the containers with suitable lifting means for transferring the container from a land vehicle to a ship and vice versa, as well as to facilitate the positioning and securing together of containers in a stack relationship. U.S. Pat. No. 3,044,653 discloses in detail the method of coupling the containers together when they are being stacked and such is incorporated herein by reference.

Replacing all of such trailers with stackable and/or multi-container capable trailers would be very expensive.

### SUMMARY

In accordance with certain aspects of the disclosure a kit is disclosed for adding functionality to a trailer for use with a tractor for transporting containers, the trailer including an elongated body, at least two wheels attached to a rear portion of the elongated body, and a landing gear attached to a front portion of the elongated body. The kit includes at least two wheel receiving assemblies attachable to the elongated body at a position corresponding to a location of the wheels, each wheel receiving assembly including a central body portion, a fixed upper hook attached to the central body portion, a movable lower hook attachable to the central body portion, and a wheel cradle attached to the central body portion, the wheel receiving assembly configured to be attachable to the elongated body by the upper hook, central body portion and lower hook. The trailer may have another like trailer stacked upon it by placing respective wheels of the like trailer on respective wheel cradles of the trailer. Various options and modifications are possible.

For example, the kit may include four of the wheel receiving assemblies, or each of the at least two wheels of the trailer includes dual wheels, and the wheel cradles are configured to receive dual wheels. Also, the lower hooks may be separable from the central body portion and attachable via fastening members. If desired, a landing gear receiving assembly may be attachable to the landing gear, the landing gear receiving assembly including an extending body portion configured to be attachable to the landing gear, whereby the trailer may have another like trailer stacked upon it by placing the landing gear of the like trailer in the landing gear receiving assembly before stacking.

The kit may also include at least two container mounting assemblies attachable to the elongated body at a position corresponding to a location of mounting structure of a container, each container mounting assembly including a central arm portion, a fixed upper hook attached to the central arm portion, a movable lower hook attachable to the central arm portion, and a container mounting structure attached to the central arm portion, the container mounting assembly configured to be attachable to the elongated body by the upper hook, central arm portion and lower hook. The trailer may have a container of a given size attached to it by connecting the respective mounting structure of the container with respective container mounting structure of the container mounting assemblies. If desired, kit may include four of the container mounting assemblies. The container mounting assemblies may be configured and mounted to the trailer at respective locations so as to correspond to the size of a shipping container, whereby equipment used to lift a shipping container may also be used to lift the trailer via the container mounting assemblies. The container mounting structures may be configured to receive twist locks, and their lower hooks may be separable from the central arm portions and attachable by fastening members. Their central arm portions may be configured to extend non-orthogonally with respect to the elongated body.

According to other aspects of the disclosure a kit is disclosed for adding functionality to a trailer for use with a tractor for transporting containers, the trailer including an elongated body, at least two wheels attached to a rear portion of the elongated body, and a landing gear attached to a front portion of the elongated body. The kit includes a number of wheel receiving assemblies corresponding to the number of wheels on the trailer, each wheel receiving assembly being attachable to the elongated body at a position corresponding to a location of a respective one of the wheels, each wheel receiving assembly including a central body portion, a fixed upper hook attached to the central body portion, a movable lower hook attachable to the central body portion, and a wheel cradle attached to the central body portion, the wheel receiving assembly configured to be attachable to the elongated body by the upper hook, central body portion and lower hook. A landing gear receiving assembly is attachable to the landing gear, the landing gear receiving assembly including an extending body portion configured to be attachable to the landing gear, whereby the trailer may have another like trailer stacked upon it by placing the landing gear of the like trailer in the landing gear receiving assembly before stacking and by placing respective wheels of the like trailer on respective wheel cradles of the trailer. Four container mounting assemblies are attachable to the elongated body at respective positions corresponding to a location of mounting structure of a container, each container mounting assembly including a central arm portion, a fixed upper hook attached to the central arm portion, a movable lower hook attachable to the central arm portion, and a container mounting structure attached to the central arm portion, the container mounting assembly configured to be attachable to the elongated body by the upper hook, central arm portion and lower hook. The trailer may have a container of a given size attached to it by connecting the respective mounting structure of the container with respective container mounting structure of the container mounting assemblies, and the container mounting assemblies being configured and mounted to the trailer at respective locations so as to correspond to the size of a shipping container. Equipment used to lift a shipping container may also be used to lift the trailer via the container mounting assemblies. The scope of the disclosure includes a trailer in combination with this and other kits, and various options and modifications are possible.

According to other aspects of the disclosure, a kit is disclosed for adding functionality to a trailer for use with a tractor for transporting containers, the trailer including an elongated body, at least two wheels attached to a rear portion of the elongated body, and a landing gear attached to a front portion of the elongated body. The kit includes four container mounting assemblies attachable to the elongated body at respective positions corresponding to a location of mounting structure of a container, each container mounting assembly including a central arm portion, a fixed upper hook attached to the central arm portion, a movable lower hook attachable to the central arm portion, and a container mounting structure attached to the central arm portion, the container mounting assembly configured to be attachable to the elongated body by the upper hook, central arm portion and lower hook, whereby the trailer may have a container of a given size attached to it by connecting the respective mounting structure of the container with respective container mounting structure of the container mounting assemblies, the container mounting assemblies being configured and mounted to the trailer at respective locations so as to correspond to the size of a shipping container. Equipment used to lift a shipping container may also be used to lift the trailer via the container mounting assemblies. As above, various options and modifications are possible.

According to other aspects of the disclosure, a wheel receiving assembly is disclosed for attachment to a trailer to assist in stacking multiple of such trailers, each trailer including an elongated body including a beam. The wheel receiving assembly includes a central body portion, a fixed upper hook attached to the central body portion, a movable lower hook attachable to the central body portion, and a wheel cradle attached to the central body portion, the wheel receiving assembly configured to be attachable to the elongated body by placing the upper hook over the beam, the central body portion against the beam, and the lower hook under the beam, with the lower hook attached to the central portion, whereby the trailer may have another like trailer stacked upon it by placing respective wheels of the like trailer on respective wheel cradles of the trailer. Again, various options and modifications are possible. For example, the wheel cradle may be configured with an indentation on at least one side thereof for positioning the wheel receiving assembly on the beam at a given spot aligned with a tire of the trailer while avoiding structure of the trailer.

According to other aspects of the disclosure, a container mounting assembly is disclosed for attachment to a trailer for use with a tractor for transporting containers, the trailer including an elongated body including a beam. The container mounting assembly includes a central arm portion, a fixed upper hook attached to the central arm portion, a movable lower hook attachable to the central arm portion, and a container mounting structure attached to the central arm portion, the container mounting assembly configured to be attachable to the elongated body by placing the upper hook over the beam, the central arm portion against the beam, and the lower hook under the beam, with the lower hook attached to the central portion, whereby the trailer may have a container of a given size attached to it by connecting the respective mounting structure of the container with respective container mounting structure of the container mounting assembly, the container mounting assemblies being configured and mounted to the trailer at respective locations so as to correspond to the size of a shipping container. Equipment used to lift a shipping container may also be used to lift the trailer via the container mounting assemblies. Again, various options and modifications are possible.

Particular embodiments of the trailers and stackable features of the trailers, the kits, and the components are described in greater detail below by reference to the examples in the drawings.

### BRIEF DESCRIPTION OF THE DRAWINGS

FIG. 1 is a perspective view of an embodiment of a stackable trailer according to the invention showing trailers being stacked one upon the other.

FIG. 2 is a perspective view illustrating the positioning bar of the trailer.

FIG. 3 is a side-elevational view illustrating stacked trailers.

FIG. 4 is partial side-elevational view illustrating the position of the landing gear of a trailer when one trailer is stacked on top of another trailer.

FIG. 5 is a partial plan view illustrating the positioning bar on top of another trailer.

FIG. 6 is a perspective view illustrating the positions of a 40 foot and 20 foot container on a trailer.

FIG. 7 is a fragmentary perspective view illustrating the supporting arm for container connector receiver and a container connector prior to being inserting into the container connector receiver.

FIG. 8 is a partial perspective view illustrating a container connector positioned to be inserted into a corner post of a container.

FIG. 9 is a partial perspective view illustrating a container connector locking a container onto a lateral support arm.

FIG. 10 is a side-elevational view illustrating the position of a 20 foot and 40 foot container when loaded on a trailer.

FIG. 11 is a side-elevational view illustrating a crane in schematic form lifting a stackable container.

FIG. 12 is a perspective view of one example of a cradle assembly according to certain aspects of the disclosure.

FIG. 13 is a side view of the cradle assembly of FIG. 12, showing attachment to a beam.

FIG. 14 is a front view of the cradle assembly of FIG. 12.

FIG. 15 is a rear view of the cradle assembly of FIG. 12.

FIG. 16 is a perspective view of another example of a cradle assembly according to certain aspects of the disclosure.

FIG. 17 is a left side view of the cradle assembly of FIG. 16, showing attachment to a beam.

FIG. 18 is a right side view of the cradle assembly of FIG. 16, showing attachment to a beam.

FIG. 19 is a front view of the cradle assembly of FIG. 16.

FIG. 20 is a rear view of the cradle assembly of FIG. 16.

FIG. 21 is a top view of the cradle assembly of FIG. 16.

FIG. 22 is a bottom view of the cradle assembly of FIG. 16.

FIG. 23 is a perspective view of an example of a landing gear receiving assembly according to certain aspects of the disclosure.

FIG. 24 is an end view of the landing gear receiving assembly of FIG. 23.

FIG. 25 is a perspective view of an example of a container mounting assembly according to certain aspects of the disclosure.

FIG. 26 is a right side view of the container mounting assembly of FIG. 25, showing attachment to a beam.

FIG. 27 is a top view of the container mounting assembly of FIG. 25.

FIG. 28 is a bottom view of the container mounting assembly of FIG. 25.

FIG. 29 is a front view of the container mounting assembly of FIG. 25.

FIG. 30 is a rear view of the container mounting assembly of FIG. 25.

FIG. 31 is a schematic view of a trailer frame with a number of kit components attached to it.

### DETAILED DESCRIPTION OF THE PREFERRED EMBODIMENTS

Reference will now be made to embodiments of the invention, one or more examples of which are illustrated in the figures. The embodiments are provided by way of explanation of the invention, and are not meant as a limitation of the invention. For example, features illustrated or described as part of one embodiment may be used with another embodiment to yield still a further embodiment. It is intended that the present invention encompass these and other modifications and variations as come within the scope and spirit of the invention.

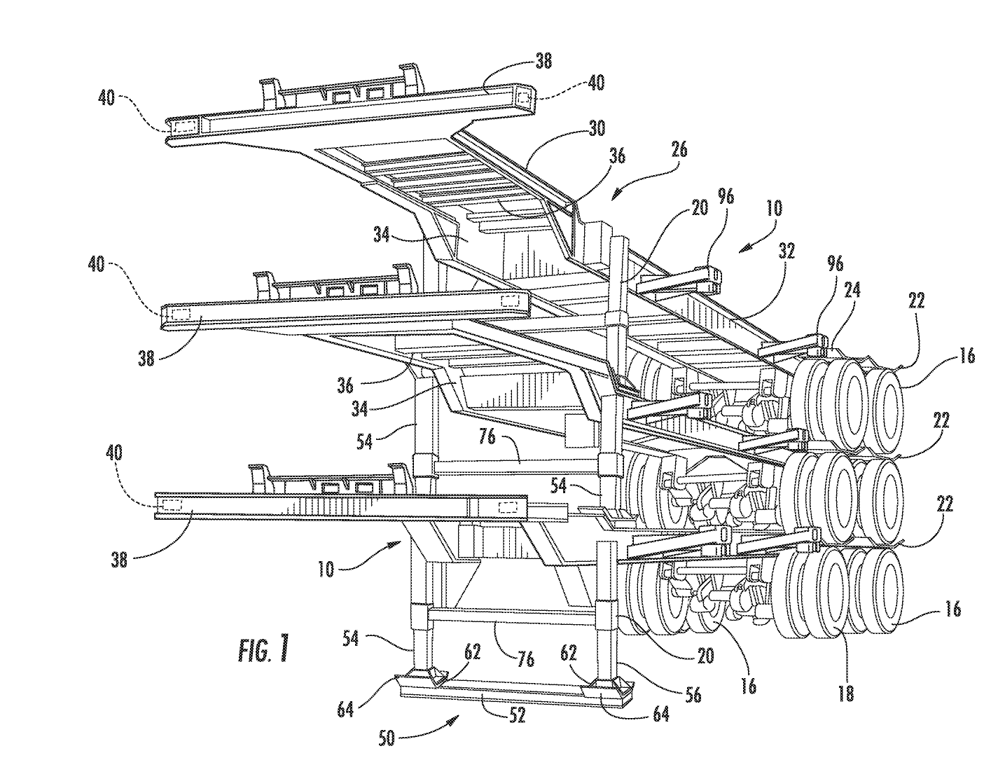

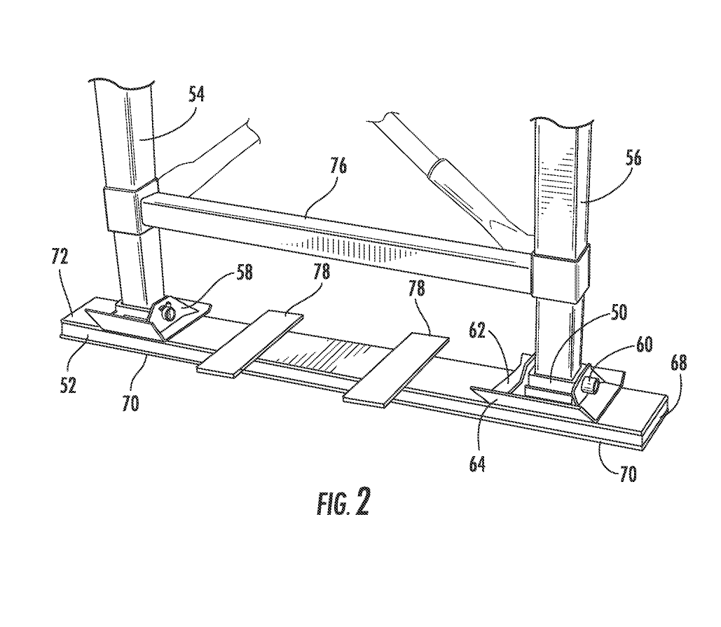

Referring to FIG. 1, three trailers 10 stacked upon each other. Each of the stackable trailers includes an elongated body 12 that has a supporting surface 14 provided thereon upon which a container is positioned when being transported. There are two sets of wheels 16 and 18 carried adjacent the rear end of the elongated body 12 for supporting the rear of the trailer. A retractable landing gear 20 extends downwardly adjacent the front end of the trailer 10 for supporting the trailer on the ground and in the stacked position on top of another trailer. There are two pairs 22, 24 of wheel receivers positioned directly over the wheels 16, 18 of the trailer 10 but below the supporting surface 14 of the trailer. These wheel receivers 22, 24 are provided for receiving the wheels 16, 18 of a trailer that is stacked on top when the trailers are in a stacked configuration.

A goose neck 26 is provided adjacent a front end of the elongated body 12 and includes an inclined surface 28 which terminates in a forwardly extending nose 30. The trailer 10 as shown is a conventional goose neck trailer that is equipped with wheels and braking systems and a pin for fitting in a fifth wheel of tractor. The pin and tractor connection are not disclosed since it is well-known in the industry. Many aspects of the disclosure do not require a goose neck trailer though.

The trailer 10 is constructed of laterally spaced I-beams 32, 34 which have suitable transverse metal bracing 36 extending therebetween. Positioned adjacent the front end of the trailer is a cross bar 38 that has a conventional locking pin 40 that is used for locking the front end of a container onto the trailer. The mechanism for manipulating the locking pin 40 is not disclosed since it is conventional on goose neck trailers that are constructed for carrying containers. Any suitable connector could be used for locking the front end of a 40 foot container on the trailer.

Normally the trailer has eight wheels carried on the rear end thereof with two sets of four wheels 16, 18 provided on respective spaced axles. As shown in the drawings, there are four wheels on each side of the rear end of the trailer.

Conventional twist locks 42 are carried on the rear end of the trailer and are mounted in a cross bar 44. The twist locks 42 are provided with mechanical or electromechanically operated levers so as to rotate camming surfaces 90 degrees to lock the lower end of the containers onto the trailer. The upper end of the twist lock 42 fits within a hole provided on the corner posts 48 of the containers for locking the containers down onto the trailer. Any suitable conventional locking mechanism could be utilized for locking the containers onto the trailers. As shown, cross bars 38 and 44 are spaced to fit a 40 foot trailer. The cross bars could have other spacing for other container sizes, such as 20 foot, if desired.

Each of the trailers is provided with a landing gear 20. The landing gear 20 is equipped with a conventional mechanism for raising and lowering the landing gear in a telescoping manner. When the landing gear is lowered, the foot 50 of the landing gear rests on the ground for supporting the front end of the trailer. When the trailers are stacked the foot 50 rests on the next adjacent lower trailer. The foot 50 includes a positioning bar 52 that extends between the vertically extending telescoping posts 54, 56. A connector plate 58 is pivotally connected by a pivot bolt 60 to the bottom of the vertically extending posts 56, 54. Interposed between the connector plate 58 and the positioning bar 52 is an incline plate (sometimes called a sand shoe) 62. If desired the landing gear may be placed on the ground using such plates 62. Also, such plates 62 may include small wheels (not shown) on either side. In such case, pivot bolt 60 would also comprise an axle of such wheels).

As shown, the incline plate 62 includes a forward angle portion 64 that extends upwardly at an angle of 55 degrees and an intermediate horizontal portion 66 which is attached between the connector plate 58 and the positioning bar 52. One possible purpose of the inclined front portion 64 is to aid in positioning a trailer on top of another trailer when the trailers are being stacked. The inclined portion 64 would abut against the 55 degrees inclined surface 28 forming part of the goose neck of the lower trailer. The inclined plate 64 could be positioned on the bottom surface of the positioning bar 52 rather than between the connector plate 58 and the positioning bar 52.

The positioning bar 52 in one particular embodiment includes an elongated 2×10 board 68 which is sandwiched between metal plates 70, 72. The metal plate 70 would rest on the asphalt when the trailer is on the ground. In one embodiment, the edges of the bottom plate 70 are beveled to prevent the plate 70 from digging into the asphalt surface when being supported thereon. When the inclined plate 64 is positioned on the bottom surface of the positioning bar 52 as a result of the front and rear sides being inclined upwardly they would not have the tendency to dig into the asphalt surface.

Suitable conventional angle braces 74 extend from the vertically extending telescoping posts 54, 56 and the I-Beams 32 and 34 forming part of the trailer. A cross brace 76 is also positioned between the vertically extending posts 56, 54. Additional bracing could be utilized if found necessary to strengthen the landing gear.

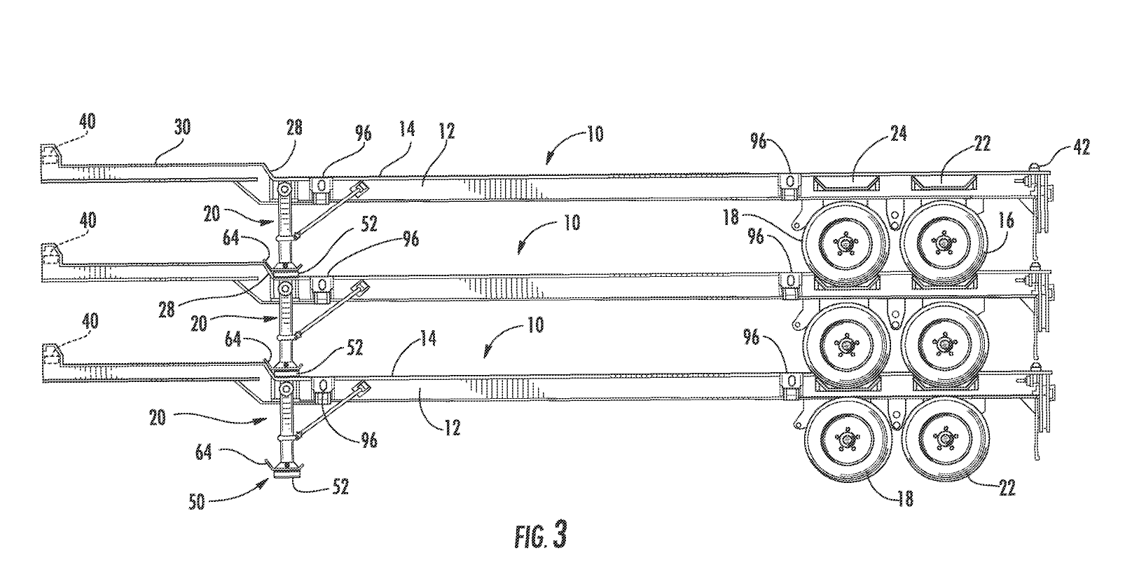

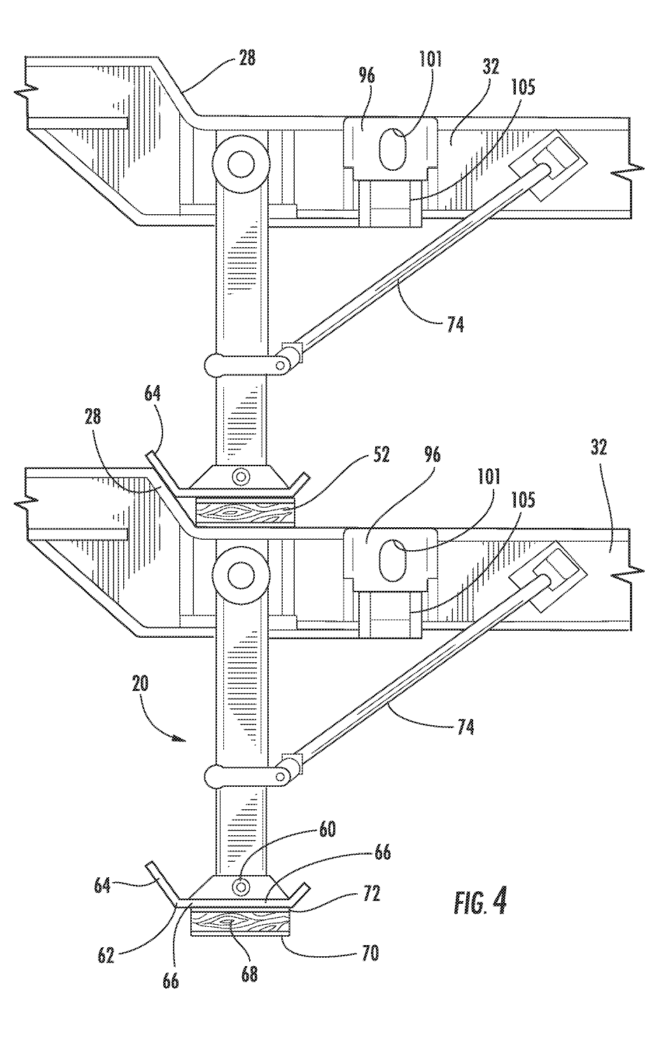

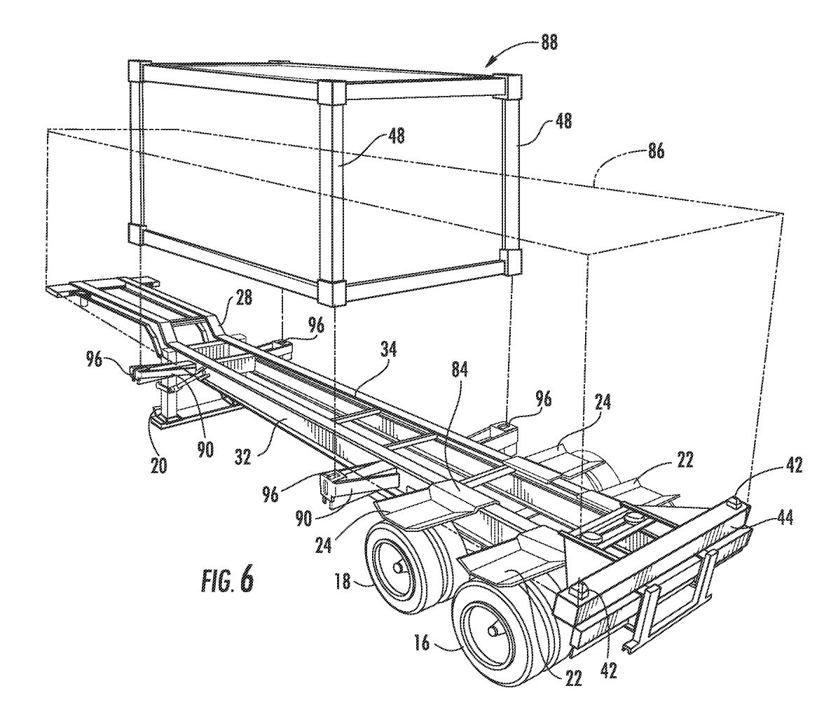

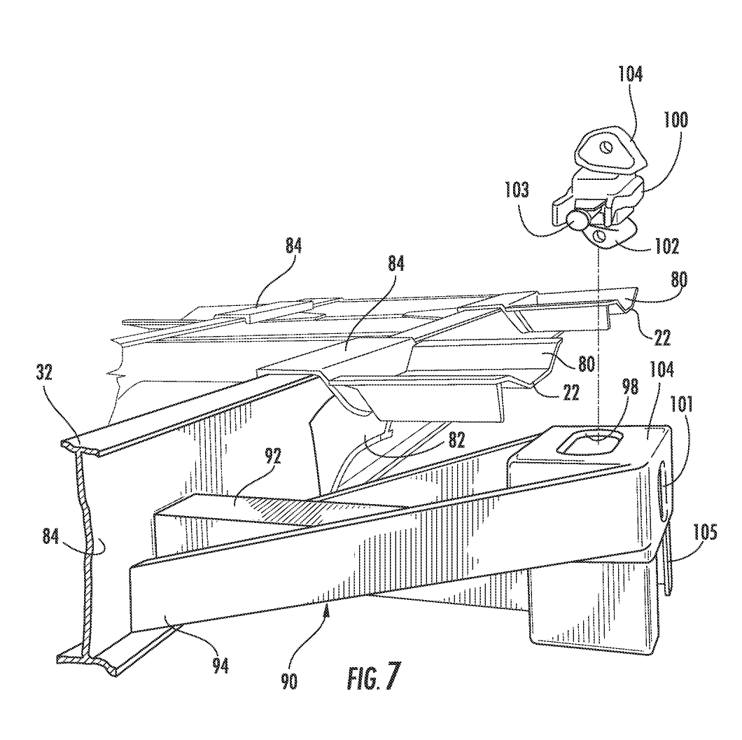

The wheel receivers 22, 24 as shown in FIGS. 3 and 6 through 9 are welded to the I-beams 32, 34 respectively, directly over the wheels 16, 18. The wheel receivers 22 and 24 have a contoured surface 80 corresponding to the curvature of the tire of the trailer so that when a tire is supported in the wheel receiver it can nest therein. The contoured surface 80 is made out of metal and is welded to the I-beams 32, 34 as shown in FIG. 6. Suitable bracing 82 extends from the vertical portion 84 of the I-beam 32 as shown in FIG. 7. This bracing 82 provides a connection between the vertical flange of the I-beam and the lower portion of the wheel receivers 24 and 26 for supporting the wheel receiver on the I-beam. In U.S. Pat. No. 5,934,695, the wheel receivers 22 and 24 were removably attached to the I-beams, however, they could also be fixed by welding to the I-beam as shown in FIG. 7. In FIGS. 7 and 8, there is a flange 84 that extends up and over top of the I-beam 32 for aiding in supporting the wheel receivers 22, 24. In some embodiments it may be desired to remove the flange 84 and only use bracing between the cradle 80 of the wheel receivers 22, 24 and the vertical extending flange of the I-beam. Such would permit the upper supporting surface of the I-beam 32 to be flat and smooth and enable the upper edge of the wheel receivers to be below the upper supporting flanges of the I-beams 32, 34.

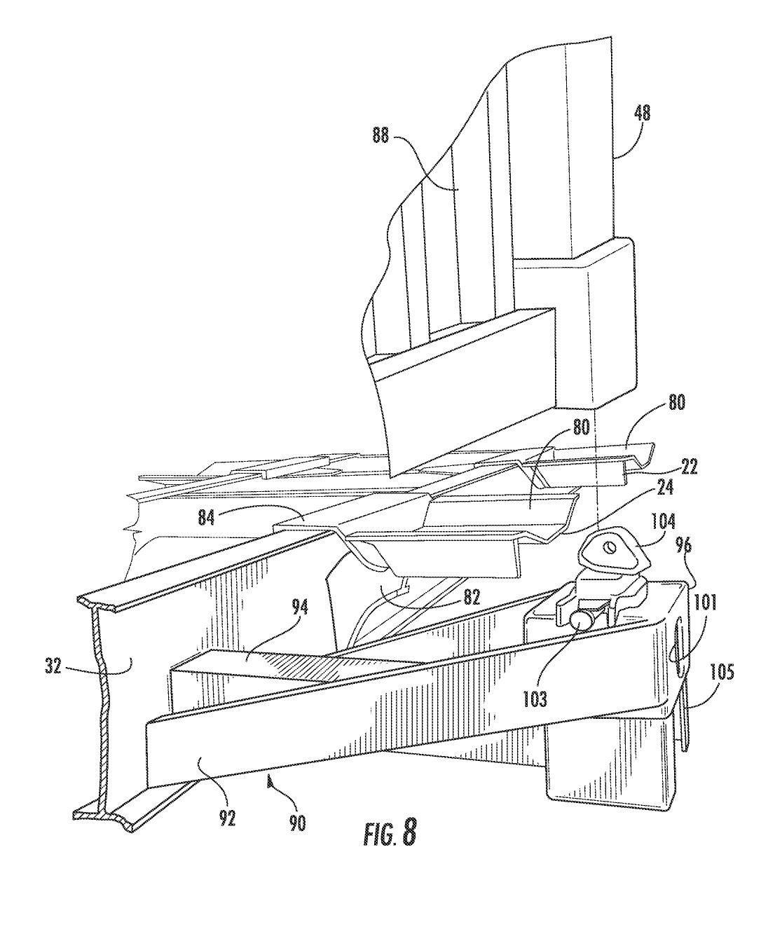

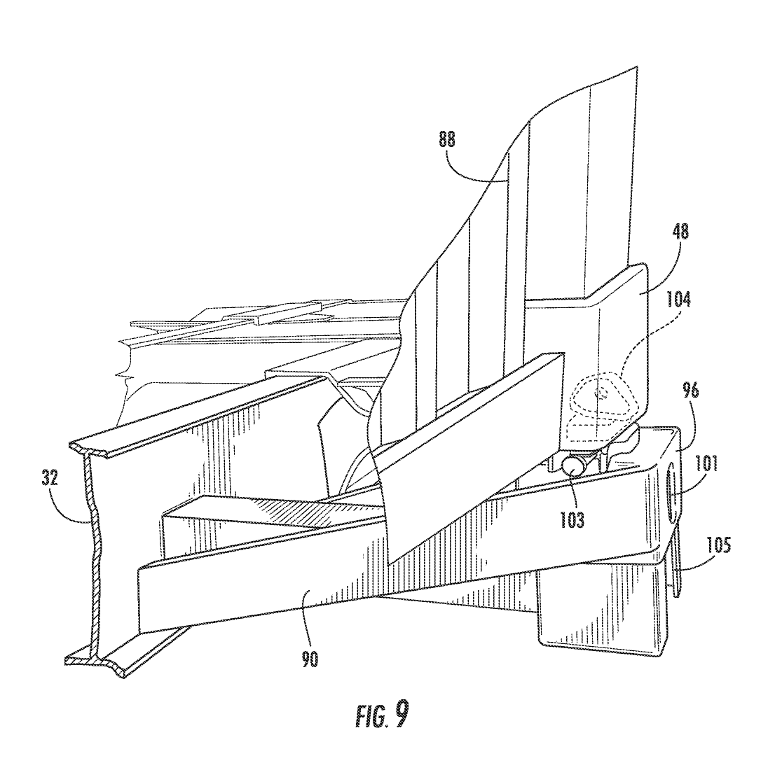

Referring to FIG. 6, there is shown in dotted lines the position of a forty foot container 86 when it is mounted on the trailer for being transported. In order for the trailer to transport a 20 foot container 88 four sets of outwardly extending support arms 90 are supported on the I-beams 32, 34 and extend laterally outwardly therefrom. The outwardly extending support arms 90 are positioned on the I-beams 32, 34 as shown in FIG. 6 so that the weight of a container 80 would be balanced between the front and rear of the trailer in order to minimize overloading of the rear wheels of the trailer or the rear wheels of the tractor pulling the trailer. A container connector receiver 96 is connected by welding or any other suitable means to the outward extending arms 92, 94. This connector receiver 96 is in the form of a hollowed block which has an opening 98 provided in the top thereof so that a container connector such as a twist lock connector 100 can be inserted therein. The twist lock connector 100 has moveable flanges 102, 104 that can be rotated so that the lower flange 102 bears on the underside of the top surface 104 of the container connector receiver. The upper camming surface 104 is inserted through an opening provided in the lower end of a corner post of the container as shown in FIG. 9 for locking the container down onto the supporting arms through the container connector receivers 96.

The twist locks 100 can be removed from the container connector receivers 96 when the trailer is being used for transporting a forty foot container. However, when a longshoreman is loading a twenty foot container 88 onto the trailer he first inserts the twist lock connector 100 into the opening 98 of the container connector receivers 96. Once the container is positioned on the trailer with the upper cramming surface 104 extending into the corner post 80 of the container, the twist lock member is manipulated by a lever or a spring loaded plunger 103 to rotate the camming surfaces 102, 104 90 degrees for locking the container 88 onto the four laterally extending support arms. An access to the plunger 103 or a lever if used is provided through an opening 101 in an end wall of the container connector receiver 96 or an opening 105 in the side wall. The twist lock connectors 100 are conventional twist locks that are in use now for locking the rear end of containers on trailers and also for use when stacking containers one upon the other to lock a bottom of one container to the top of a container positioned therebelow. The twist lock connectors 100 extend into the corner posts of the containers for locking the containers in stacks by rotating the camming surfaces 102 and 104 90 degrees.

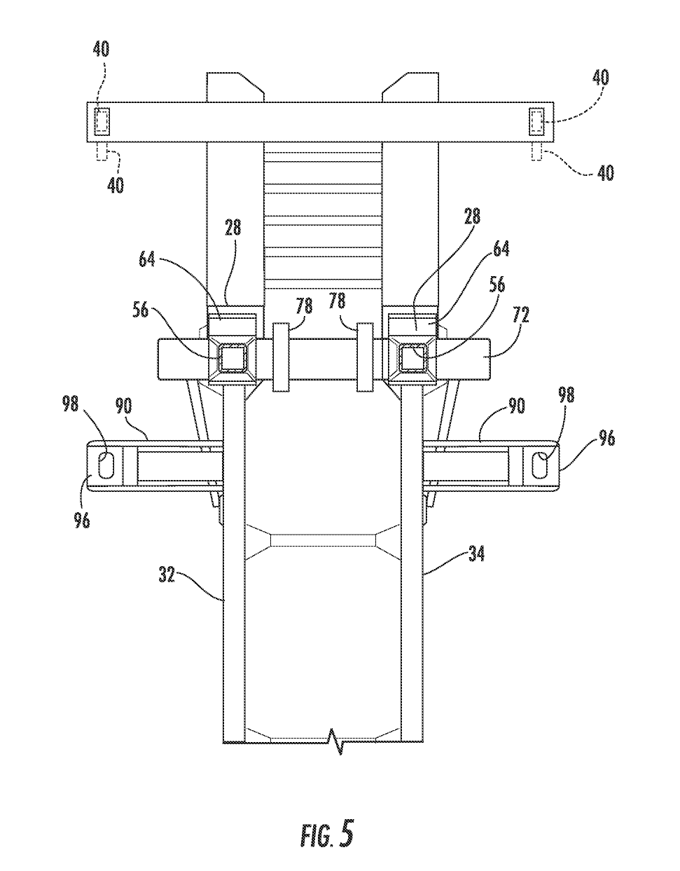

As can be seen in FIGS. 3 and 5 the container connector receivers 96 are laterally supported outwardly from the I-beams 32 and 34 on both sides of the trailer so that there are four container connector receivers 96 used for locking a twenty foot container onto the trailer. A first pair of container connector receivers 96 is positioned near the rear wheels of the trailer with a second pair of container connector receivers being located close to the landing gear. When a twenty foot container is transported on the trailer it presents a balanced load. A balanced load along the length of the trailer provides a smoother ride on the highway and minimizes damages to the highway as compared to when one set of wheels or the other is overloaded. It should be understood that various mounting locations are possible.

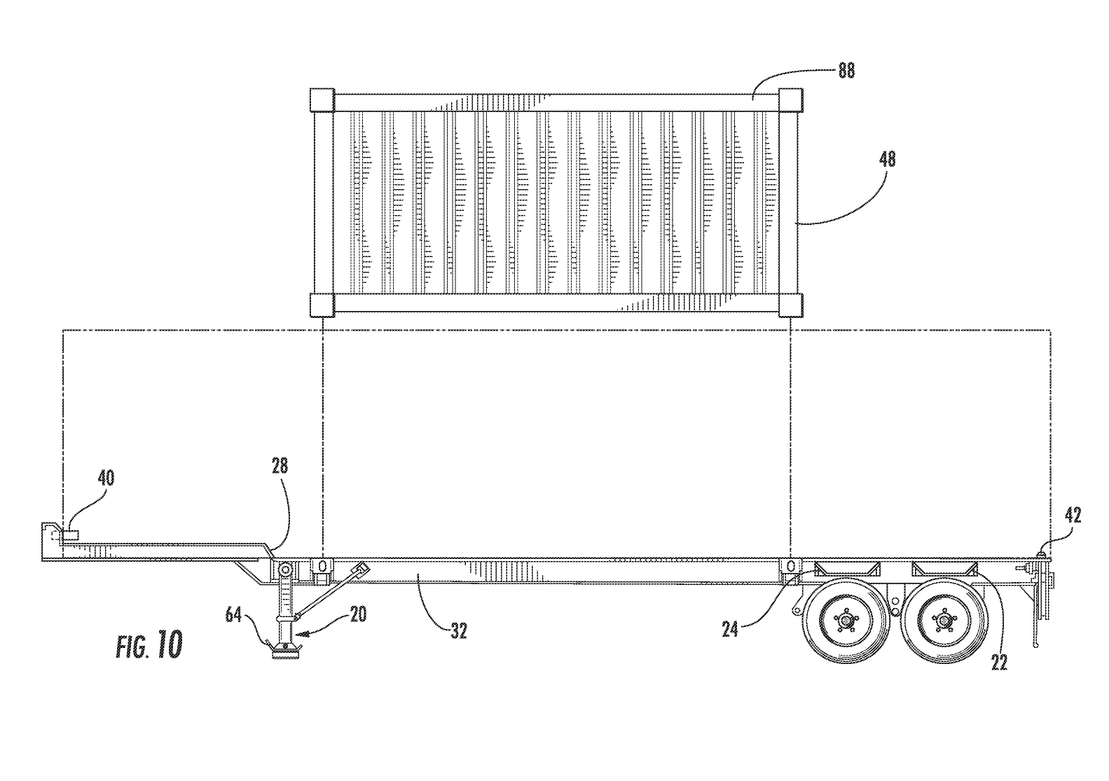

FIG. 11 illustrates an overhead crane 110 lifting the trailers for stacking one upon the other. While the overhead crane 110 shown in FIG. 11 is in a fixed position it is understood that the overhead crane could be mounted on wheels. When the overhead crane is mounted on wheels it enables the crane to move to where the trailers are being stacked or unstacked for moving them to a loading or unloading position. The crane 110 shown in FIG. 11 lifts a trailer off the ground and moves it over another trailer so that it can be lowered on top of the second trailer with the rear wheels of the upper trailer nesting in the wheel receivers 22 and 24 of the lower trailer. The inclined plates 62 carried by the positioning bar may nest against the incline surface 28 of the goose neck of the lower trailer, if such goose neck is present.

In order to couple the trailer to the crane any suitable connectors 100 could be used between a frame of the crane and the laterally spaced support arms which support the container connector receivers 96. In one particular embodiment, conventional twist locks are used. The twist locks are inserted in the container connector receivers 96 and the crane has mechanisms for engaging such twist locks similar to the way that the present prior art cranes are being used to lift containers off of ships. The trailers can also be stacked on container ships or barges in order to transfer trailers from one port to another. If desired, forklifts or other lifting devices and structures may be used.

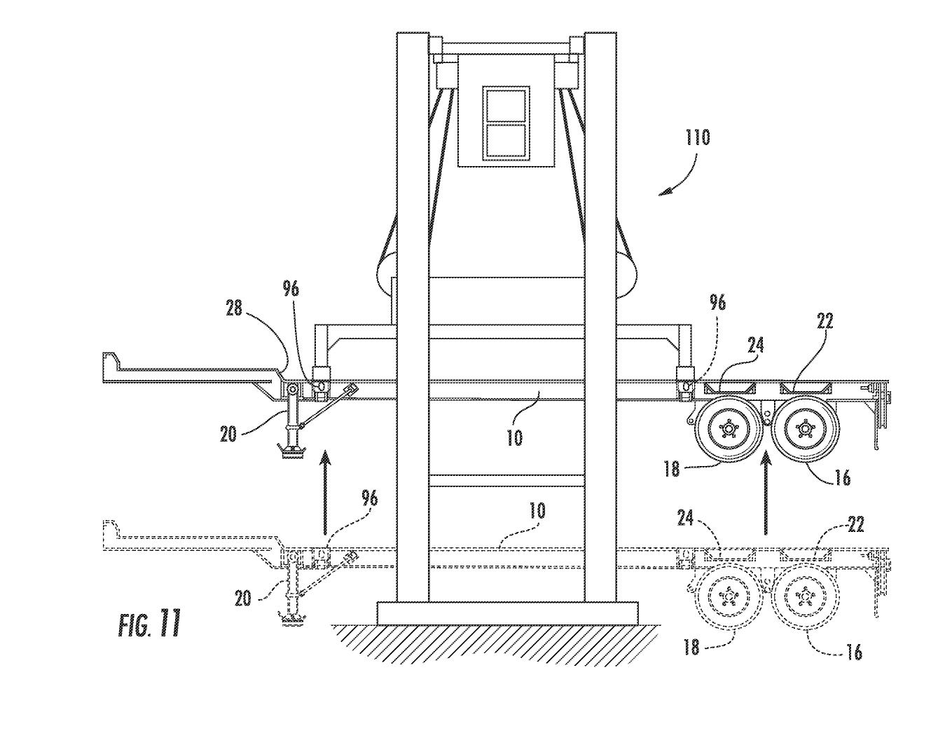

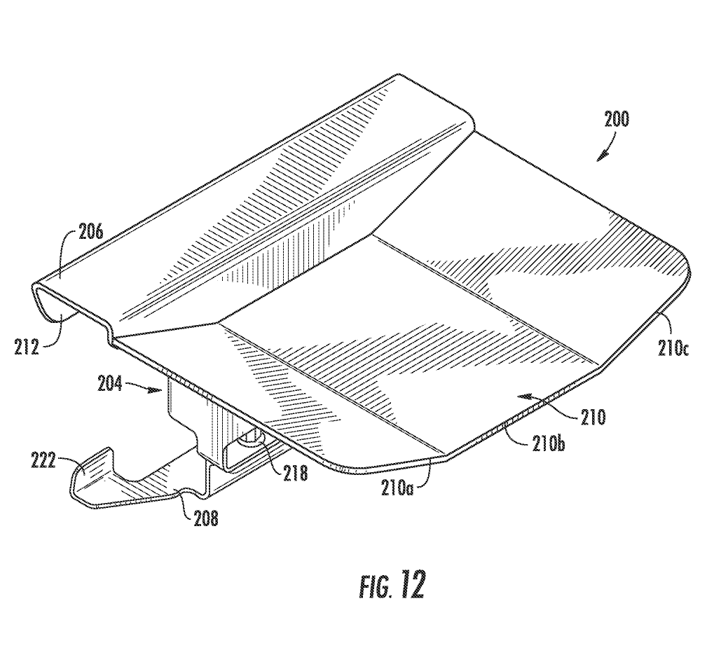

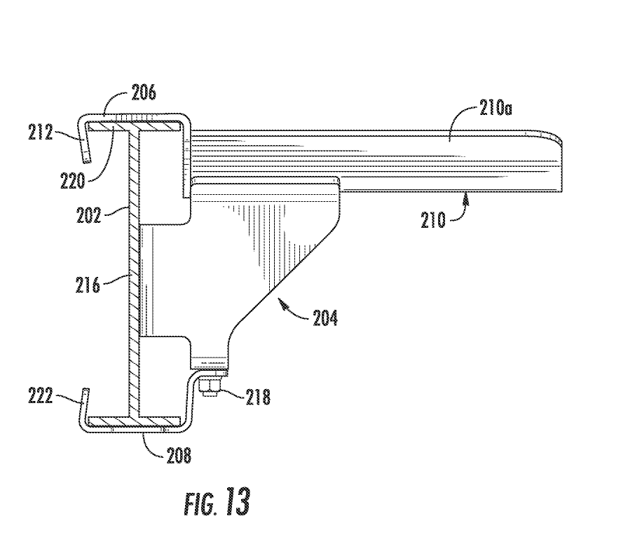

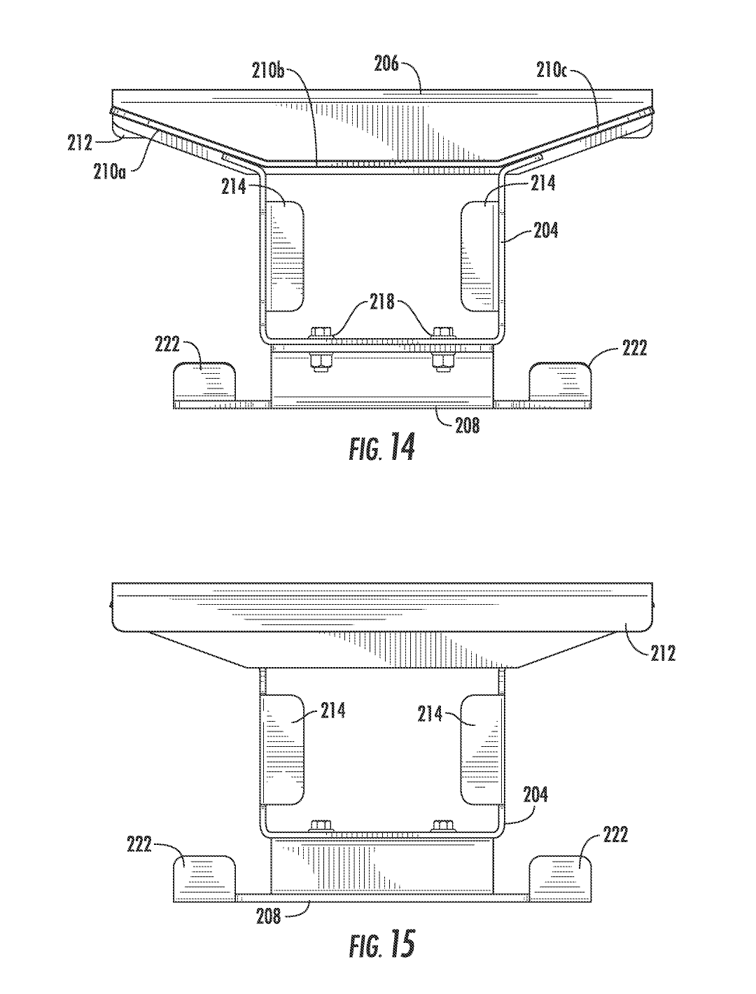

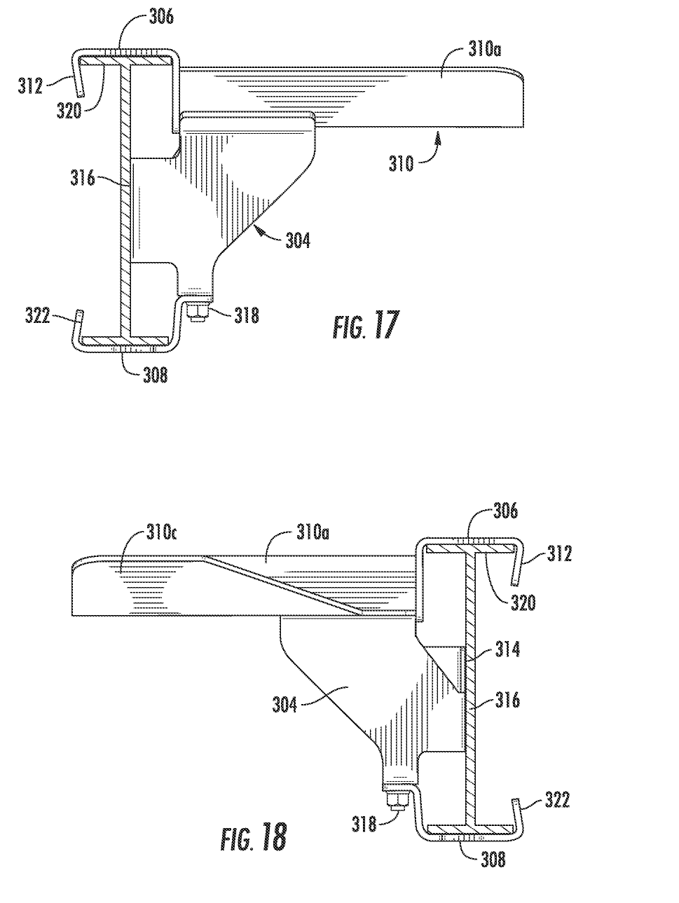

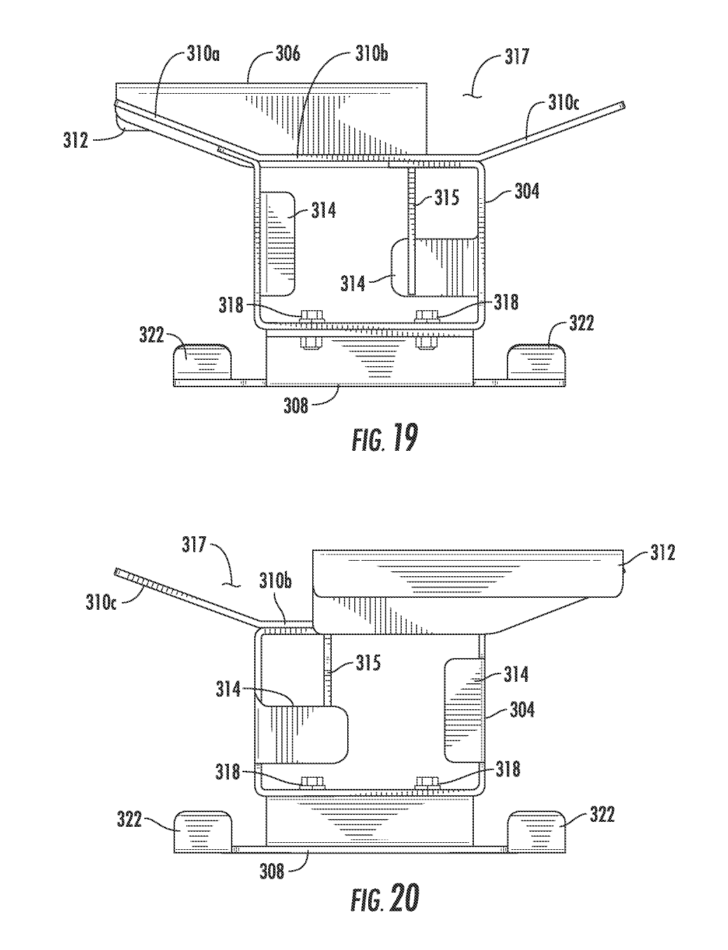

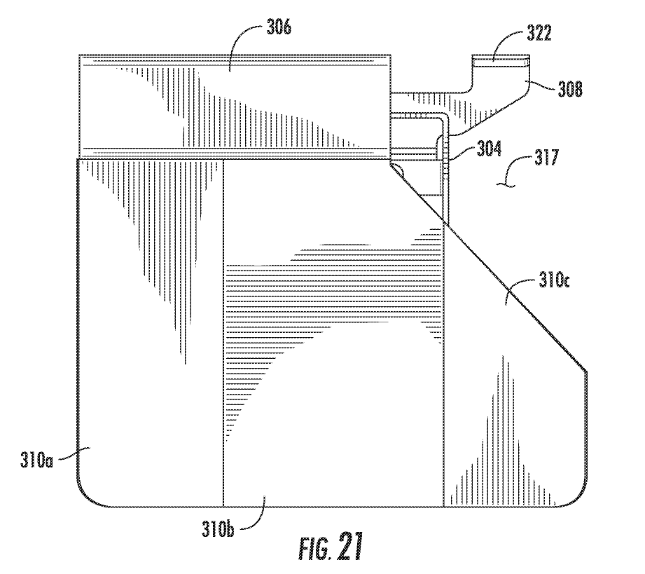

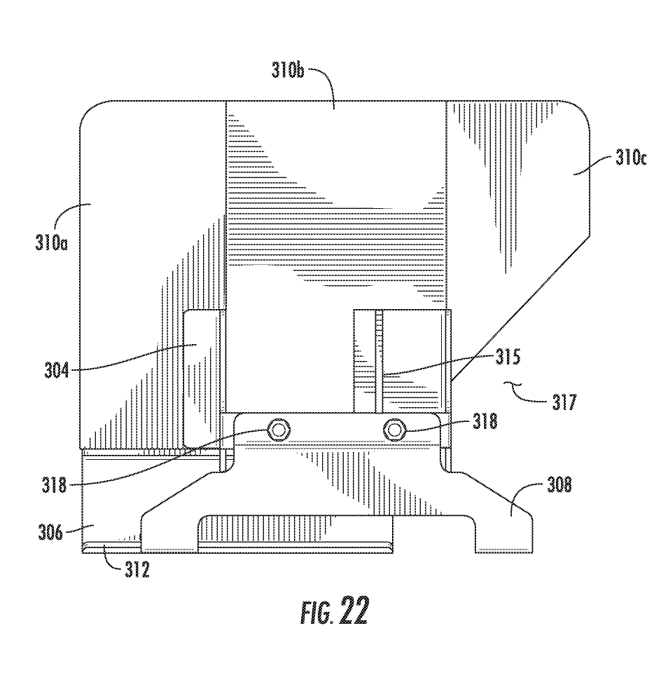

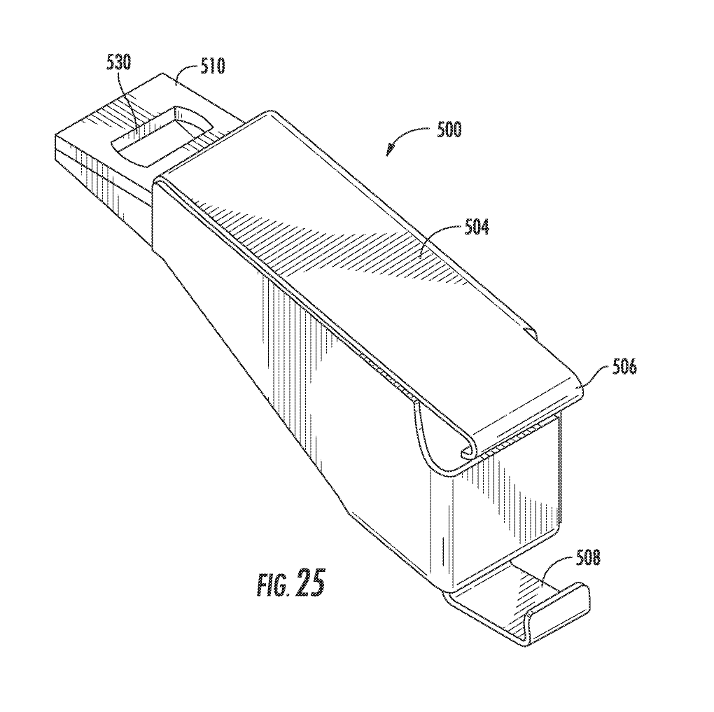

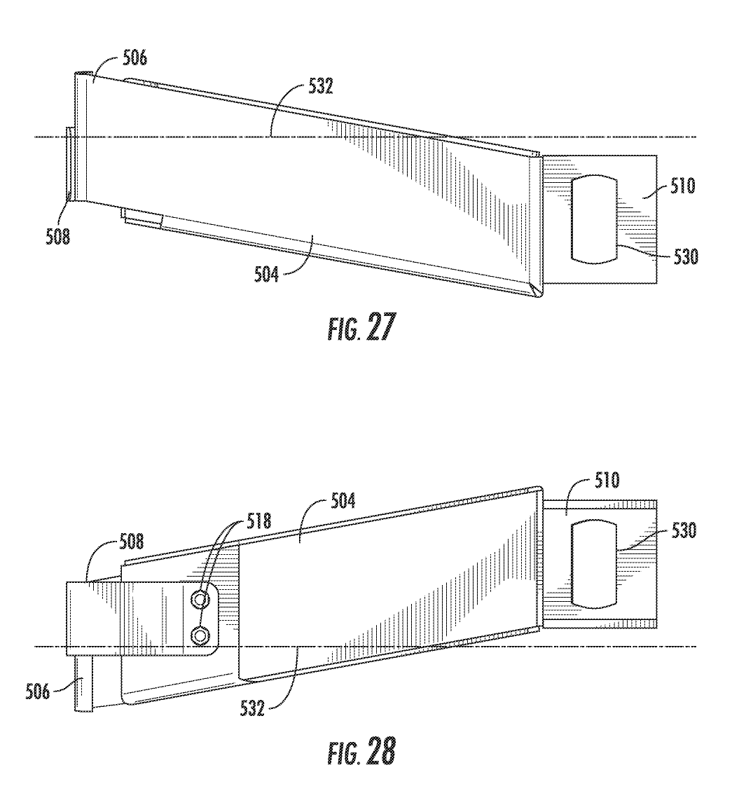

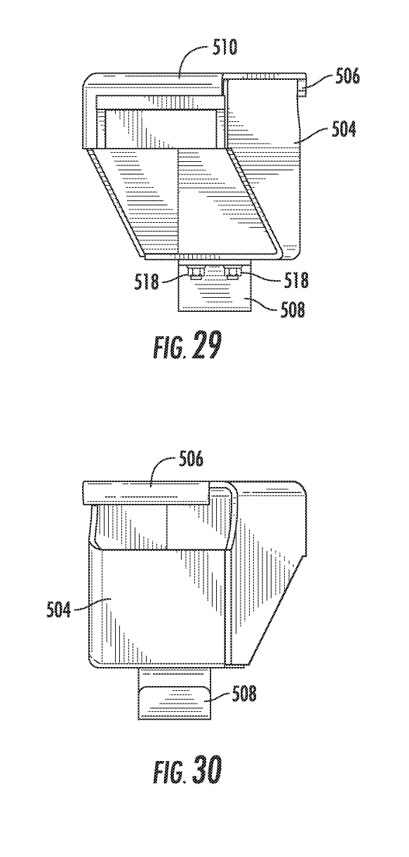

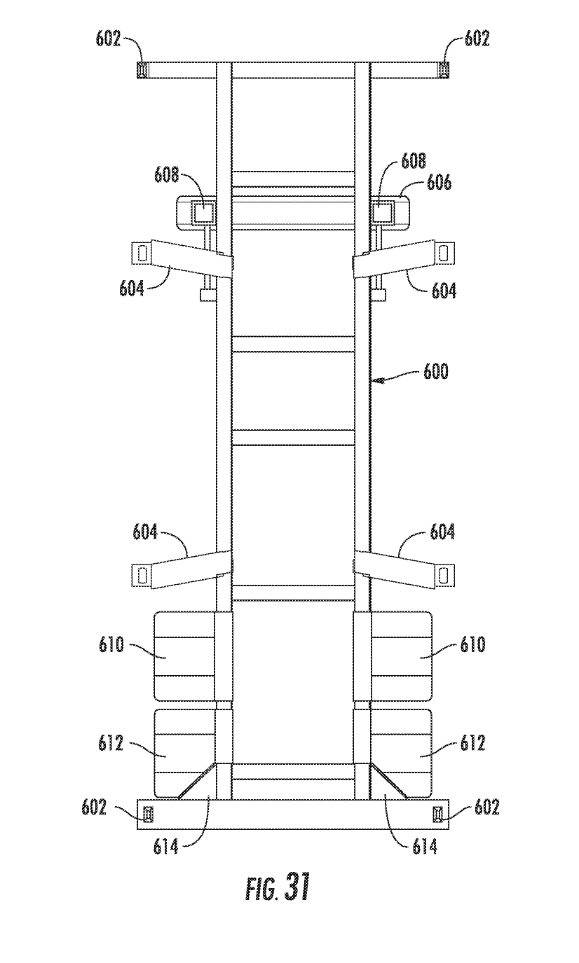

If desired, as shown in FIGS. 12-31, components may be employed for providing such stacking and 20/40 foot interoperability to existing trailers. Thus, such components can be considered a kit to be added to trailers, either by an OEM or new trailer customizer, or in the aftermarket as retrofit parts. Such components need not all be used together, as certain functionality and options are provided by certain components, and the benefits of the individual components may be employed separately. The components are all readily and economically manufactured, and are easily attached to and removed from trailers as desired. Therefore, substantial benefits are provided by using one or more components as described below.

FIGS. 12-15 show one example of a separate wheel receiving assembly that could be attached to a trailer. Such assembly might also be called a cradle or a saddle, due to the shape. As depicted therein, wheel receiving assembly 200 is attachable to the elongated body of the trailer, for example at beam 202. Assembly 200 is attachable at a position corresponding to a location of at least one wheel on the trailer, as described above.

Each wheel receiving assembly 200 includes a central body portion 204, a fixed upper hook 206 attached to the central body portion, a movable lower hook 208 attachable to the central body portion, and a wheel cradle 210 attached to the central body portion. As shown, a downward depending part 212 of hook 206 fits over beam 202. Flanges 214 of central body portion 204 contact a central area 216 of beam 202. Fastening members 218 such as nuts and bolts may be employed to attach movable lower hook 208 to central body portion 204. Alternately, if desired (not shown), lower hook 208 may pivot down or sideways relative to central body portion 204. Lower hook 208 is movable in such fashion so that the assembly may be readily yet securely attached to and removed from beam 202. Thus, to attach the assembly, lower hook 208 is loosed or removed entirely, and upper hook 206 is placed over top portion 220 of beam 202. Upper hook 206 and cradle 210 are then pivoted down until flanges 214 contact beam 202. Then, lower hook 208 is attached and/or tightened to hold cradle assembly 200 to beam 202. The wheel receiving assembly 200 is thus configured to be attachable to the beam 202 by the upper hook 206, central body portion 204, and lower hook 208.

It should be understood that the individual shapes of assembly 200 may be modified to some extent. For example, cradle 210 could have more or less than three planar sections (sections 210a, b, and c are shown), and the angles of outer sections 210a and 210c could be changed. Also, cradle 210 could be curved, whether circular or otherwise, sized in relation to a tire to be held. Cradle 210 is shown roughly sized to support an inner tire of a two tire pair, but could be wider if desired. As noted above, alternate attachments and connections between the lower hook 208 and the rest of the cradle assembly are possible as well. Also, upper hook 204 is shown as having one depending portion 212 and lower hook 208 has two upwardly extending portions 222. The number of extensions and their arrangement could be modified as desired, in particular to meet the particular configuration of a given trailer, its supports, cross-bars, etc. Also, more or fewer fastening elements 218 could be employed.

Cradle assemblies 200 should be strong enough to support a proportional amount of the weight of a stack of trailers above. Therefore, a high tensile strength steel alloy would be suitable. Domex 110 in ¼ inch plate, cut to size, formed and welded is one possibility, although other materials can be used.

Certain trailers include triangular reinforcing frame portions at the rear to provide additional rigidity to the trailer. As shown, examples of such elements 97 of trailer 10 are shown in FIG. 6. It should be understood that variations exist in trailers currently in use. For example, some plates are higher, some lower; some are atop the beams and some are flush. Therefore, to fit a cradle assembly to a position where it would be centered relative to the rearmost wheel on a given trailer, it might be necessary to modify the cradle assembly from that shown in FIGS. 12-15.

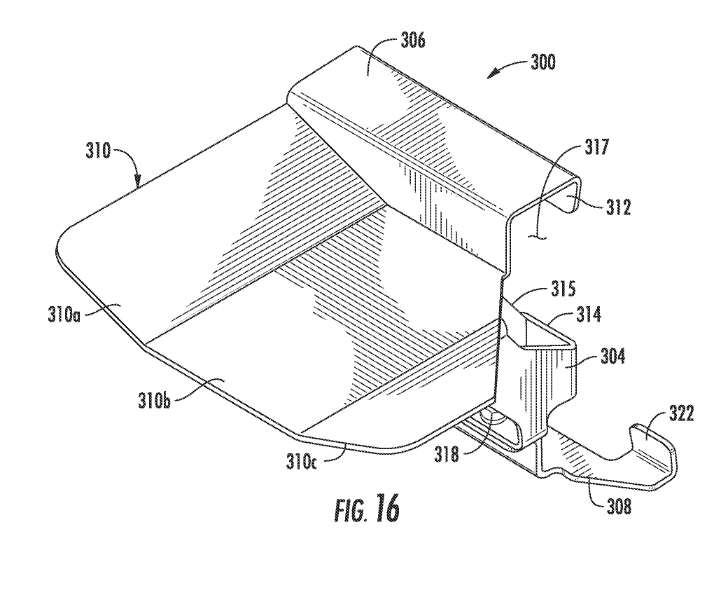

One example of a modified cradle assembly 300 is shown in FIGS. 16-22. Cradle assembly 300 is somewhat similar to cradle assembly 200, and like reference numerals are employed where possible between the embodiments. Thus, cradle assembly includes a central body portion 304, a fixed upper hook 306 attached to the central body portion, a movable lower hook 308 attachable to the central body portion, and a wheel cradle 310 attached to the central body portion. Hook 306 fits over beam 302 with portion 312 depending downward. Lower hook 308 includes upwardly extending portions 322. Flanges 314 of central body portion 304 contact a central area 316 of beam 302. Fastening members 318 attach hook 308 to central body portion 304, although the connections options above are again possible.

Cradle 310 and body portion 304 have been modified by removing a portion to fit against a triangular frame portion such as portion 97. Flanges 314 have been modified and supplemented with a web 315 to provide added strength in view of the removal of some material as compared to the previous embodiment. The exact modification can be done on a case-by-case basis in view of a given trailer. Further, the modification need not be made in view of a triangular reinforcing support. Cradle assemblies can be modified so as to fit around beams of varying width, beams with longitudinal reinforcing, cross-beams, etc. Thus, it should be understood that the two examples of cradles shown above are not to be considered limiting of the inventive cradle concepts. It should also be understood that modifications could be made symmetrically to create cradles that would suit opposite sides of the trailer.

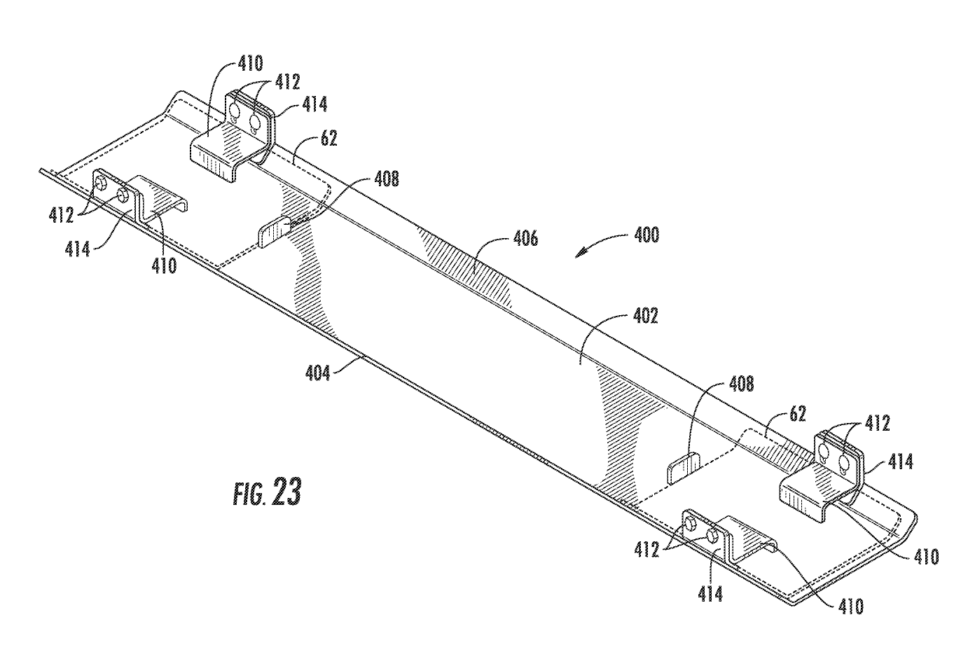

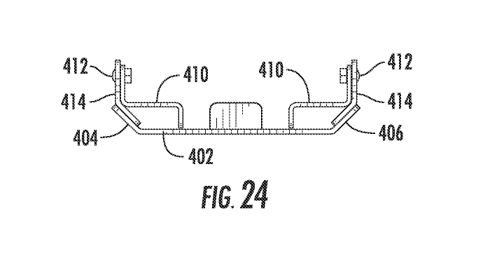

FIGS. 23 and 24 show an example of a landing gear receiving assembly 400 attachable to a landing gear of a trailer. As shown, landing gear receiving assembly 400 includes an extending body portion 402. Edges 404 and 406 of the body portion 402 may be bent upward, as with edges of sand shoes 62, discussed above. Body portion 402 and edges 404 and 406 should be configured large enough to fit the landing gear ends on them without deformation, and should be strong enough to support the weight of the particular trailer and any stacked above it. Also, body portion 402 should be long enough to receive and support any wheels present on a landing gear. Positioning tabs 408 may be provided to help position receiving assembly relative to the landing gear. Holding elements 410 may be provided to secure the landing gear to the body portion, for example by capturing sand shoes 62 (shown in dotted lines in FIG. 23) therebetween once attached. If desired, holding elements 410 may be attached to body portion via fasteners 412 and integral or attached extensions 414, or holding elements 410 may be attached directly to body portion 402. If desired, holding tabs could be eliminated and other structures for releasably attaching body portion to the landing gear could be employed, such as hooks, other types of fasteners, etc. Assembly 400 may also be made of ¼ inch Domex 100 or other suitable material.

FIGS. 25-30 show one example of a container mounting assembly 500 for attachment to a trailer including a beam 502. Container mounting assembly 500 is in the form of an outrigger that may include a central arm portion 504, a fixed upper hook 506 attached to the central arm portion, a movable lower hook 508 attachable to the central arm portion, and a container mounting structure 510 attached to the central arm portion. Like the cradle assemblies above, container mounting assembly 500 is configured to be attachable to beam 502 by placing the upper hook 506 over the beam, central arm portion 514 against the beam, and lower hook 508 under the beam. Accordingly, by placing a plurality of such assemblies 500 on a trailer, a trailer may have a container of a given size attached to it by connecting the respective mounting structure of the container with respective container mounting structure of the container mounting assembly. The container mounting assemblies can be mounted to the trailer at respective locations so as to correspond to the size of a shipping container. Thus four such assemblies could be attached for a 20 or even a 40 foot container, or a container of any size that would fit the trailer. Alternately, two such assemblies could be used along with two structures permanently attached to the trailer for structures smaller than the maximum trailer size. Therefore, use of two or more of such assemblies provides flexibility in using trailers so that perhaps only one size of trailer could be used in a port to receive multiple sizes of containers. Again, Domex 110 or other suitable materials can be employed.

Also, the mounting structure openings 530 can be configured so as to fit connectors used by forklifts or cranes for moving containers. Therefore, the outriggers can serve a dual purpose of adjustably securing shipping containers of various sizes using existing trailers and allowing devices already in ports to be used to move and stack trailers.

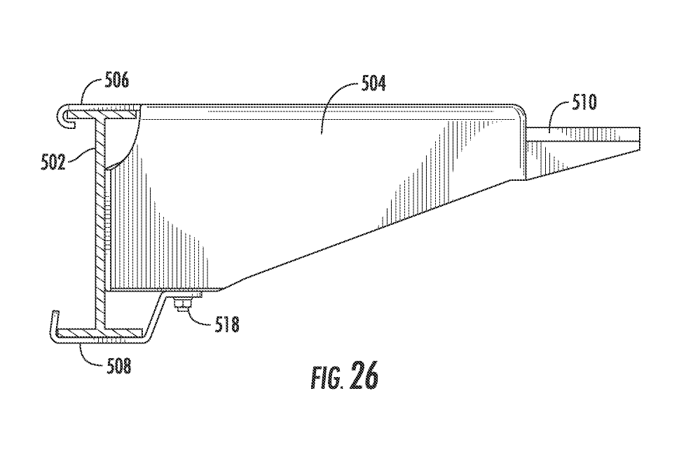

As shown best in FIG. 27, central arm portion 514 can be configured so as to extend non-orthogonally from beam 502 (non-symmetrical along longitudinal axis 532). Such structure, while not required, can provide added rigidity and security to a container on a trailer, be reducing bending a twisting tendencies. If such is provided, then a symmetrical extension in opposite directions may be desired along and across a trailer.

FIG. 31 shows a schematic view of on possible arrangement of a kit of component parts on a trailer. As shown, trailer frame 600 has mounting structures 602 to accept a 40 foot container thereon. Four outriggers 604 are provided, 20 feet apart, to receive 20 foot container. If desired, only two such outriggers 604 could be used in conjunction with two of the structures 602, or the outriggers could be placed alternately. A landing gear receiving assembly 606 is provided attached to landing gear feet 608. Pairs of first and second cradle assemblies 610, 612 are attached to trailer frame 600 at spots corresponding to wheels (not shown in FIG. 31 for clarity). Note that reinforcing elements 614 are provided on trailer frame 600, so cradle assemblies 612 are configured to fit adjacent such reinforcing elements while still being in position relative to the respective wheels.

It should be understood that the arrangement outlined in FIG. 31 is but one possible kit for use with a trailer. Many variations of such a kit using some, all, or additional parts, and parts attached to trailer frame 600 in various ways, are all possible within the scope of the present disclosure. For example, the trailers may be lashed or otherwise secured together by their frames or by the frames, landing gear assemblies, saddle assemblies and/or the outrigger assemblies for adding stability during use or for shipping groups of stacked trailers.

Therefore, it should be understood that the types of structures, devices and methods utilized with the teachings of the present disclosure should not be limited to those embodiments shown herein. It should also be understood that features of the various embodiments above may be recombined in other ways to achieve still further embodiments within the scope of the present invention.

What is claimed:

1. A kit for adding functionality to a trailer for use with a tractor for transporting containers, the trailer including an elongated body, at least two wheels attached to a rear portion of the elongated body, and a landing gear attached to a front portion of the elongated body, the kit comprising:
at least two wheel receiving assemblies attachable to the elongated body at a position corresponding to a location of the wheels, each wheel receiving assembly including a central body portion, a fixed upper hook attached to the central body portion, a movable lower hook attachable to the central body portion, and a wheel cradle attached to the central body portion, the wheel receiving assembly configured to be attachable to the elongated body by the upper hook, central body portion and lower hook, whereby the trailer may have another like trailer stacked upon it by placing respective wheels of the like trailer on respective wheel cradles of the trailer.

2. The kit of claim 1, wherein the kit includes four of the wheel receiving assemblies.

3. The kit of claim 1, wherein each of the at least two wheels of the trailer includes dual wheels, and the wheel cradles are configured to receive dual wheels.

4. The kit of claim 1, wherein the lower hooks are separable from the central body portion and attachable via fastening members.

5. The kit of claim 1, further including a landing gear receiving assembly attachable to the landing gear, the landing gear receiving assembly including an extending body portion configured to be attachable to the landing gear, whereby the trailer may have another like trailer stacked upon it by placing the landing gear of the like trailer in the landing gear receiving assembly before stacking.

6. The kit of claim 1, further including at least two container mounting assemblies attachable to the elongated body at a position corresponding to a location of mounting structure of a container, each container mounting assembly including a central arm portion, a fixed upper hook attached to the central arm portion, a movable lower hook attachable to the central arm portion, and a container mounting structure attached to the central arm portion, the container mounting assembly configured to be attachable to the elongated body by the upper hook, central arm portion and lower hook, whereby the trailer may have a container of a given size attached to it by connecting the respective mounting structure of the container with respective container mounting structure of the container mounting assemblies.

7. The kit of claim 6, wherein the kit includes four of the container mounting assemblies.

8. The kit of claim 7, wherein the container mounting assemblies are configured and mounted to the trailer at respective locations so as to correspond to the size of a shipping container, whereby equipment used to lift a shipping container may also be used to lift the trailer via the container mounting assemblies.

9. The kit of claim 6, wherein the container mounting structures are configured to receive twist locks.

10. The kit of claim 6, wherein the lower hooks are separable from the central arm portions and attachable by fastening members.

11. The kit of claim 6, wherein the central arm portions are configured to extend non-orthogonally with respect to the elongated body.

12. A kit for adding functionality to a trailer for use with a tractor for transporting containers, the trailer including an elongated body, at least two wheels attached to a rear portion of the elongated body, and a landing gear attached to a front portion of the elongated body, the kit comprising:
a number of wheel receiving assemblies corresponding to the number of wheels on the trailer, each wheel receiving assembly being attachable to the elongated body at a position corresponding to a location of a respective one of the wheels, each wheel receiving assembly including a central body portion, a fixed upper hook attached to the central body portion, a movable lower hook attachable to the central body portion, and a wheel cradle attached to the central body portion, the wheel receiving assembly configured to be attachable to the elongated body by the upper hook, central body portion and lower hook;
a landing gear receiving assembly attachable to the landing gear, the landing gear receiving assembly including an extending body portion configured to be attachable to the landing gear, whereby the trailer may have another like trailer stacked upon it by placing the landing gear of the like trailer in the landing gear receiving assembly before stacking and by placing respective wheels of the like trailer on respective wheel cradles of the trailer; and
four container mounting assemblies attachable to the elongated body at respective positions corresponding to a location of mounting structure of a container, each container mounting assembly including a central arm portion, a fixed upper hook attached to the central arm portion, a movable lower hook attachable to the central arm portion, and a container mounting structure attached to the central arm portion, the container mounting assembly configured to be attachable to the elongated body by the upper hook, central arm portion and lower hook, whereby the trailer may have a container of a given size attached to it by connecting the respective mounting structure of the container with respective container mounting structure of the container mounting assemblies, and the container mounting assemblies being configured and mounted to the trailer at respective locations so as to correspond to the size of a shipping container, whereby equipment used to lift a shipping container may also be used to lift the trailer via the container mounting assemblies.

13. A stackable trailer as in claim 12, comprising the trailer and the kit.

14. A kit for adding functionality to a trailer for use with a tractor for transporting containers, the trailer including an elongated body, at least two wheels attached to a rear portion of the elongated body, and a landing gear attached to a front portion of the elongated body, the kit comprising:
four container mounting assemblies attachable to the elongated body at respective positions corresponding to a location of mounting structure of a container, each container mounting assembly including a central arm portion, a fixed upper hook attached to the central arm portion, a movable lower hook attachable to the central arm portion, and a container mounting structure attached to the central arm portion, the container mounting assembly configured to be attachable to the elongated body by the upper hook, central arm portion and lower hook, whereby the trailer may have a container of a given size attached to it by connecting the respective mounting structure of the container with respective container mounting structure of the container mounting assemblies, the container mounting assemblies being configured and mounted to the trailer at respective locations so as to correspond to the size of a shipping container, whereby equipment used to lift a shipping container may also be used to lift the trailer via the container mounting assemblies.

15. The kit of claim 14, wherein the container mounting structures are configured to receive twist locks.

16. The kit of claim 14, wherein the lower hooks are separable from the central arm portions and attachable via fastening members.

17. The kit of claim 14, wherein the central arm portions are configured to extend non-orthogonally with respect to the elongated body.

18. A wheel receiving assembly for attachment to a trailer to assist in stacking multiple of such trailers, each trailer including an elongated body including a beam, the wheel receiving assembly comprising:
a central body portion;
a fixed upper hook attached to the central body portion;
a movable lower hook attachable to the central body portion; and
a wheel cradle attached to the central body portion, the wheel receiving assembly configured to be attachable to the elongated body by placing the upper hook over the beam, the central body portion against the beam, and the lower hook under the beam, with the lower hook attached to the central portion, whereby the trailer may have another like trailer stacked upon it by placing respective wheels of the like trailer on respective wheel cradles of the trailer.

19. The assembly of claim 18, wherein the lower hook is separable from the central body portion and attachable via fastening members.

20. The assembly of claim 18, wherein the wheel cradle is configured with an indentation on at least one side thereof for positioning the wheel receiving assembly on the beam at a given spot aligned with a tire of the trailer while avoiding structure of the trailer.

21. A container mounting assembly for attachment to a trailer for use with a tractor for transporting containers, the trailer including an elongated body including a beam, the container mounting assembly comprising:
a central arm portion;
a fixed upper hook attached to the central arm portion;
a movable lower hook attachable to the central arm portion; and
a container mounting structure attached to the central arm portion, the container mounting assembly configured to be attachable to the elongated body by placing the upper hook over the beam, the central arm portion against the beam, and the lower hook under the beam, with the lower hook attached to the central portion, whereby the trailer may have a container of a given size attached to it by connecting the respective mounting structure of the container with respective container mounting structure of the container mounting assembly, the container mounting assemblies being configured and mounted to the trailer at respective locations so as to correspond to the size of a shipping container, whereby equipment used to lift a shipping container may also be used to lift the trailer via the container mounting assemblies.

22. The assembly of claim 21, wherein the container mounting structure is configured to receive a twist lock.

23. The assembly of claim 21, wherein the lower hook is separable from to the central arm portion and attachable via fastening members.

24. The assembly of claim 21, wherein the central arm portion is configured to extend non-orthogonally with respect to the beam.
